(19) United States
(12) Patent Application Publication
(10) Pub. No.: US 2004/0165242 A1
(43) Pub. Date: Aug. 26, 2004

(54) Compact optical and illumination system with reduced laser speckles

(76) Inventors: Jean-Louis Massieu, Labege Cedex (FR); Jean-Luc Basso, Labege Cedex (FR); Christophe Duthil, Labege Cedex (FR); Khalid El Akel, Labege Cedex (FR); Jean-Michael Puech, Labege Cedex (FR); Jean-Pierre Stang, Labege Cedex (FR); Patrice Thebault, Labege Cedex (FR)

Correspondence Address: Intermec Technologies Corporation, Legal Department, Attention: Paul A. Maltseff, 6001 36th Avenue West, Everett, WA, 98203, US

(21) Appl. No.: 10/294,806

(22) Filed: Nov. 13, 2002

Related U.S. Application Data
(60) Provisional application No. 60/350,481, filed on Nov. 13, 2001.
(60) Provisional application No. 60/337,780, filed on Nov. 13, 2001.
(60) Provisional application No. 60/338,026, filed on Nov. 13, 2001.

(51) Int. Cl. G02B 26/08

(52) U.S. Cl. 359/212

(57) ABSTRACT

An integrated imaging scanning system is disclosed. The said system is comprising a substrate, a light emitting element connected to the substrate for producing a beam of light directed to an insignia, a light directing element positioned relatively the light emitting element for redirecting the beam of light aimed at the insignia, a diffraction grating element to remove the speckle phenomena from the source of light, and a compound optical element for shaping the beam of light directed to the insignia.

### CROSS REFERENCE TO RELATED APPLICATIONS

This application claims priority to the U.S. provisional applications Ser. Nos. 60/350,481 filed Nov. 13, 2001, 60/338,026 filed Nov. 13, 2001, 60/337,780 filed Nov. 13, 2001,

The following U.S. patents are hereby incorporated herein by reference in their entirety: U.S. Pat. Nos. 6,081,381; 6,134,010; 6,184,981; 5,393,967; 5,648,649; 5,695,895; 4,511,220; 4,360,372; 6,073,851; 5,814,803; 5,770,847; 5,532,467; 4,978,860; 5,777,314; 6,036,094; 5,942,762; 5,892,214; 5,281,801; 4,647,143.

### BACKGROUND OF THE INVENTION

1. Field of the Invention

The present invention generally relates to integrated imaging systems for reading multiple insignia impregnated on a surface of different articles and, more particularly, to imaging system having illumination and optical modules of reduced size and cost.

2. Description of Related Art

A general concept of integrated imaging systems has been discussed in a number of U.S. patents and publications. Multiple scanning devices currently are available on a market for reading various insignia impregnated on a surface. On the other hand, the progress in the optics and illumination, light emitting and receiving components, and micro optics have reached a point when it have become apparent that new concepts for the design of compact integrated imaging systems should be applied. The challenge of designing of integrated imaging systems had evolved over the years as the scale and extend of functions assigned to devices has increased. The integration requirements have evolved in much the same way.

The previous imaging systems required physical dimensions of the scanning modules were at least as long as the optical path. A longer optical path had being desirable to create an increased scanning angle. This limitation was preventing the miniaturization of the imaging module beyond the required optical path.

The illumination module used in imaging systems for the illumination of the scanner field of view generally comprises of following elements: at least one source of light (LED or laser), which emits light into a condensing lens; a spreading lens; and a reflector directing the light beam to the desired spread angle and direction.

If the source of illumination was a laser, then the imaging system had a problem related with a laser speckle reflection. The laser speckle is typical problem arising from uneven power distribution, which resulted in creating a light interference within the beam itself and manifesting in a grain-like structure, so called speckle structure. The speckle phenomenon hinders unmodified laser light from direct application in imaging forming systems. Previously many attempts have been made to solve problems associated with laser speckle; however, all attempts resulted in expensive complex solutions not applicable for practical applications.

### BRIEF DESCRIPTION OF THE DRAWINGS

FIG. 1 is showing a simplified schematic drawing of the optical path of the imaging system

FIG. 2 is showing a simplified schematic drawing of the lighting path of the imaging system

FIG. 3 is showing a simplified schematic drawing of the progression of the laser light through multiple diffracting gratings

### DETAILED DESCRIPTION

The present invention is directed to an integrated imaging scanning system based on miniaturized illumination and optical modules and integrated in one integrated device. While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

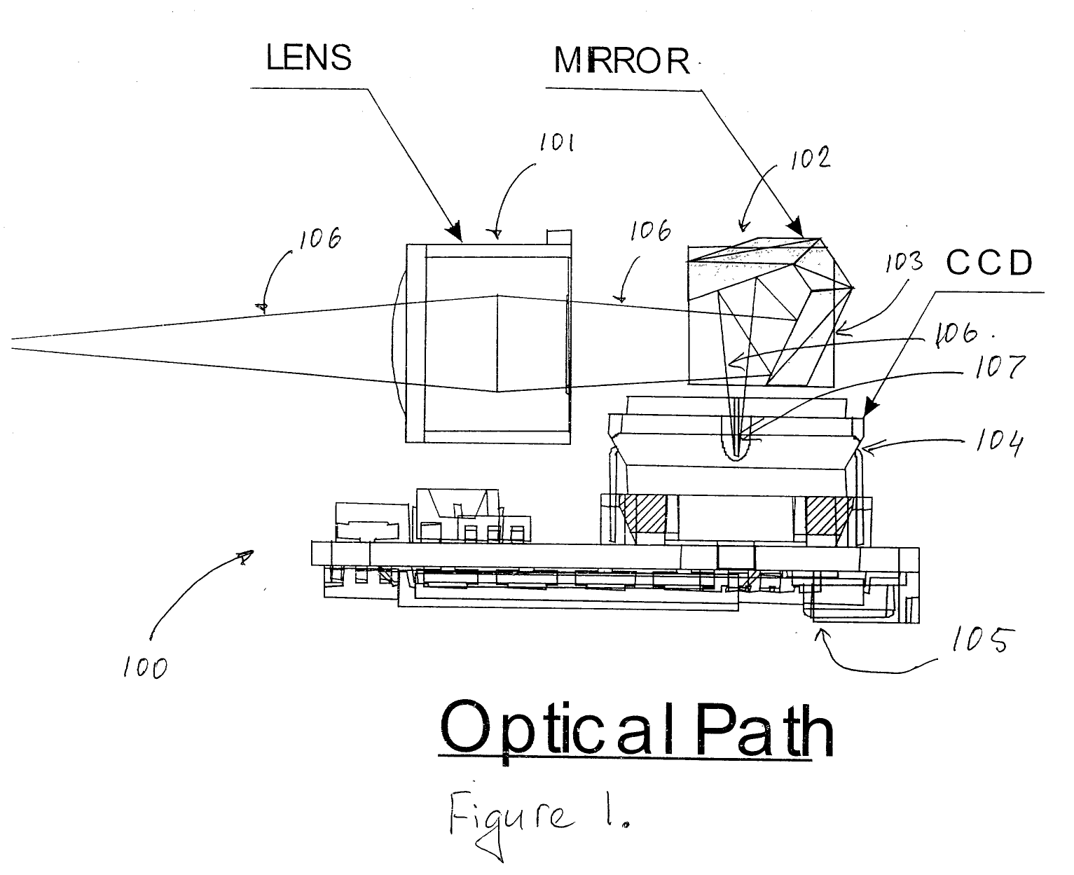

FIG. 1, shows a simplified schematic drawing of the optical path 106 of the imaging system 100. A light path of the present invention is bounces off of two mirrors 102, 103 rather than going directly to the imaging sensor 104 or being bounced off a single mirror. The two mirrors dramatically extending the optical path without requiring space for the optical path in the linear dimension to be designed into the imaging scanning module. Similarly, three of more mirrors may be used to extend the optical path even further, within a smaller space. The assembly of multiple mirrors may be further improved by assembling them into a single component resulting in considerable saving of the space and cost, as well as improved rigidity.

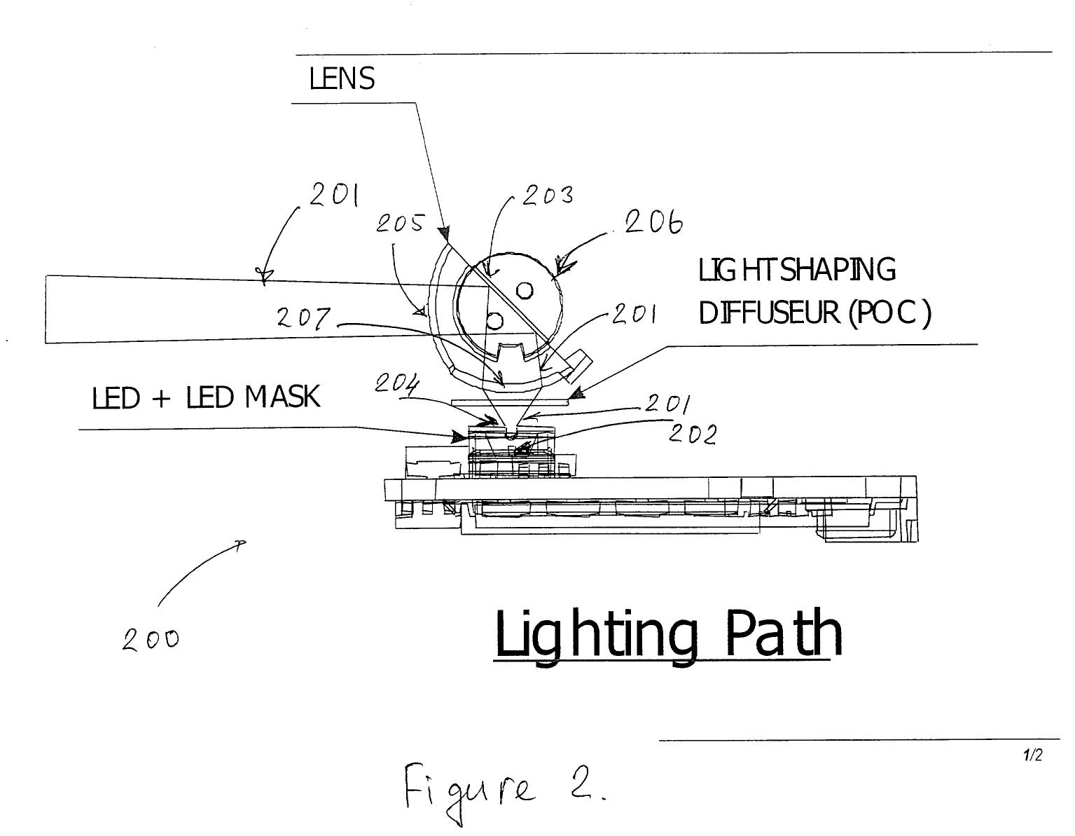

FIG. 2 is showing a simplified schematic drawing of the lighting path 201 of the imaging system 200. The invention reduces the lenses and reflector into a single optical component. The optical component may be modified or ground into a three-sided rod. The first side of the rod 207 is serving as a condenser, the second side 203 as an internal mirror and a third side 205 as the spreading lens. In addition to a material cost, there is a considerable space savings and manufacturing efficiency gain. By eliminating the reflector as a separate component from the optical assembly, the resulting module requires approximately half the space of prior art methods. As the three components are manufactured from a single optical medium, the alignment between the components may be precisely made at time of manufacturing and therefore does not depend upon lens and/or mirror holders, which add cost, complexity, and consume space. Further, the mounting of the optical components is simplified, thereby increasing overall reliability and vibration failure resistance.

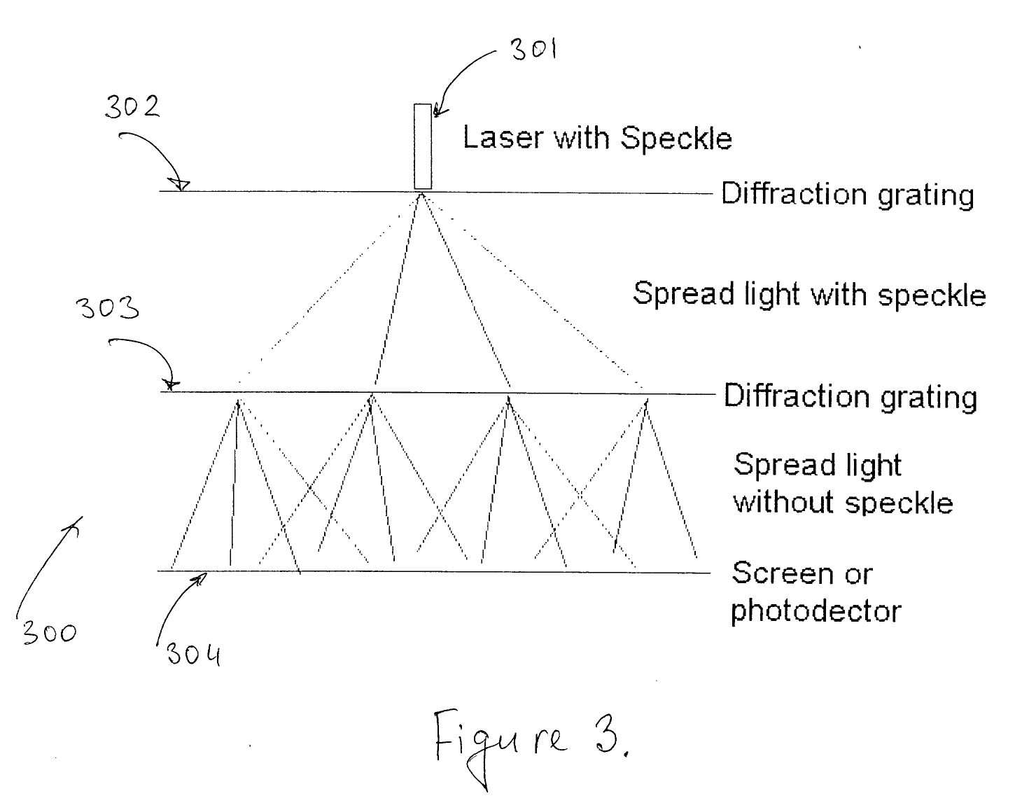

If the source of light 202 is a laser, see FIG. 2, then the present invention provide a method to significantly eliminate a laser speckle structure. FIG. 3 is showing a simplified schematic drawing of the progression of the laser light through multiple diffracting gratings. A laser source 301 is projected through a first diffraction grating, and the grating spreads the laser light. The spread light will still exhibits the speckle phenomenon. A second diffracting grating 303, spaced apart from the first diffracting grating, is diffusing a light a second time when it passes through the grating. The spread light, entering the second diffraction grating, creates a series of randomly spatially distributed coherent point sources of light, which each being spread again by the second diffracting grading. The second spreading results in the spread light without speckle creating a nearly uniform pattern on the projection surface 304. The light emanating from the second diffraction grating has effectively removed the speckle phenomenon by an order of magnitude. Additional diffraction grating may be applied each one reducing speckle another order of magnitude. The spread light without speckle may then be used, for example, to illuminate a screen or a bar code symbol or other indicia.

The present invention is simple in the implementation, has no moving parts, and utilizes diffraction gratings commonly available fro use in the laser art.

What is claimed is:

1. An integrated imaging scanning system, comprising:
a substrate;
a light emitting element connected to the substrate for producing a beam of light directed to an insignia;
a light directing element positioned relatively the light emitting element for redirecting the beam of light aimed at the insignia;
an optical element for shaping the beam of light directed to the insignia.

2. An integrated imaging scanning system of claim 1, further comprising a diffraction grating element to remove the speckle phenomena from the source of light.

3. An integrated imaging scanning system of claim 1, wherein said light directing element is composed of a compound multi-mirror structure.

4. An integrated imaging scanning system of claim 1, wherein the optical element is a three-sided rod.
